(19) United States
(12) Patent Application Publication
(10) Pub. No.: US 2002/0004837 A1
(43) Pub. Date: Jan. 10, 2002

(54) E-mail communication terminal apparatus

(75) Inventor: Kenichi Ishiguri, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Mitsubishi Denki Kabushiki Kaisha, Tokyo (JP)

(21) Appl. No.: 09/772,926

(22) Filed: Jan. 31, 2001

(30) Foreign Application Priority Data
Jul. 7, 2000 (JP) 2000-207504

(51) Int. Cl. G06F 15/16

(52) U.S. Cl. 709/231; 709/206

(57) ABSTRACT

It is intended to provide an e-mail communication terminal apparatus which, when connected to an e-mail system that is limited in the amount of data that can be communicated at one time, makes it possible to transmit and receive data having an amount larger than the limit amount. A division control section divides transmission data into divisional data based on a predetermined data amount when the transmission data has an amount larger than a limit amount of data that an e-mail system to which to establish connection can communicate at one time. A transmitting section transmits the divisional data. A receiving section receives data. A recombination control section recombines the data received by the receiving section when the received data are divisional data.

### BACKGROUND OF THE INVENTION

1. Field of the Invention

The present invention relates to an e-mail communication terminal apparatus to be connected, via a communication channel, to an e-mail system that is limited in the amount of data that can be communicated at one time.

2. Description of Related Art

An example of conventional e-mail communication terminal apparatuses is shown in FIG. 6. FIG. 6 shows the configuration of a computer network using an e-mail transfer apparatus that is disclosed in Japanese Unexamined Patent Publication No. Hei. 11-205458. In FIG. 6, reference numeral 51 denotes a computer network, which is composed of a mail server 52, an e-mail transfer apparatus 56, an Ethernet cable 53 that connects the mail server 52 and the e-mail transfer apparatus 56, a modem 54, telephone line 55a to which the modem 54 is connected and telephone line 55b to which the e-mail transfer apparatus 56 is connected, and a pager terminal 57.

Next, the operation of the above computer network will be described. E-mail that is transmitted from a transmission terminal that is connected to the telephone line 55a is stored in the mail server 52 via the modem 54. In response to a request from the e-mail transfer apparatus 56, the stored e-mail is transmitted to the e-mail transfer apparatus 56 by the mail server 52 via the Ethernet cable 53. Reading the e-mail into itself, the e-mail transfer apparatus 56 converts, in accordance with the type of pager terminal 57 at a transmission destination address, the thus-read e-mail data into data having such a format that the pager terminal 57 can receive it. Then, the e-mail transfer apparatus 56 divides the converted e-mail data into data each having a proper length so that the pager terminal 57 will be able to receive and display each data at one time, divides the converted e-mail data into a plurality of data groups in accordance with the storage capacity of the pager terminal 57 and transmits the data groups intermittently to the pager terminal 57 via the telephone line 55b.

Configured as described above, the conventional e-mail transfer apparatus has the following problems. In the case of an e-mail system that is limited in the amount of data that can be communicated at one time, if a transmission terminal transmits data having an amount larger than the limit amount, an excess part of the data is discarded in the mail server and hence not all of the data transmitted from the terminal apparatus is received by the e-mail transfer apparatus.

Further, data that have been separated from each other by the e-mail transfer apparatus and transmitted therefrom intermittently are received by the pager terminal apparatus. However, since the pager terminal has no means for recombining the received data, the user of the pager terminal cannot read the received e-mail at one time; the pager terminal is poor in ease of use. There is another problem that received data cannot be reproduced when it is image data or the like.

### SUMMARY OF THE INVENTION

The present invention has been made to solve the above problems in the art, and a first object of the invention is to provide an e-mail communication terminal apparatus which, when connected to an e-mail system that is limited in the amount of data that can be communicated at one time, makes it possible to transmit and receive data having an amount larger than the limit amount.

A second object of the invention is to provide an e-mail communication terminal apparatus which, when connected to an e-mail system that is limited in the amount of data that can be communicated at one time, makes it possible to transmit and receive data having an amount larger than the limit amount and restore reception data correctly.

A third object of the invention is to provide an e-mail communication terminal apparatus which, when connected to an e-mail system that is limited in the amount of data that can be communicated at one time, makes it possible to transmit data having an amount larger than the limit amount and which is superior in portability.

According to a first aspect of the present invention, there is provided an e-mail communication terminal apparatus to be connected to an e-mail system that is limited in an amount of data that can be communicated at one time, comprising: division control means for dividing transmission data into divisional data based on a predetermined data amount when the transmission data has an amount larger than the communicable data amount of the e-mail system; transmitting means for transmitting the divisional data produced by the division control means; receiving means for receiving data; and recombination control means for recombining the data received by the receiving means when the data are divisional data that were separated from each other by a transmission source.

According to a second aspect of the present invention, there is provided an e-mail communication terminal apparatus to be connected, by radio, to an e-mail system that is limited in an amount of data that can be communicated at one time, comprising: division control means for dividing transmission data into divisional data based on a predetermined data amount when the transmission data has an amount larger than the communicable data amount of the e-mail system; and radio transmitting means for transmitting the divisional data produced by the division control means.

The above and other objects, effects, features and advantages of the present invention will become more apparent from the following description of the embodiments thereof taken in conjunction with the accompanying drawings.

### BRIEF DESCRIPTION OF THE DRAWINGS

FIG. 1 shows an e-mail communication terminal apparatus according to an embodiment of the present invention.

FIG. 2A shows transmission data 31 that is a mail body that a user intends to transmit from the mobile telephpne 11.

FIG. 2B shows the contents of the transmission memory 14.

FIG. 2C shows the contents of the transmission buffer 15 which stores one of the divisional transmission data to which a header including division information is added.

FIGS. 3A-3C show the contents of the reception buffer 19, the contents of the reception memory 18, and reception data 41.

FIG. 4 is a flowchart showing an operation of transmitting.

FIG. 5 is a flowchart showing an operation of receiving.

FIG. 6 shows the configuration of a computer network using an e-mail transfer apparatus that is disclosed in Japanese Unexamined Patent Publication No. Hei. 11-205458.

### DETAILED DESCRIPTION OF THE PREFERRED EMBODIMENTS

Embodiments of the present invention will be described below with reference to the accompanying drawings. It is noted that the same reference symbols in the drawings denote the same or corresponding components.

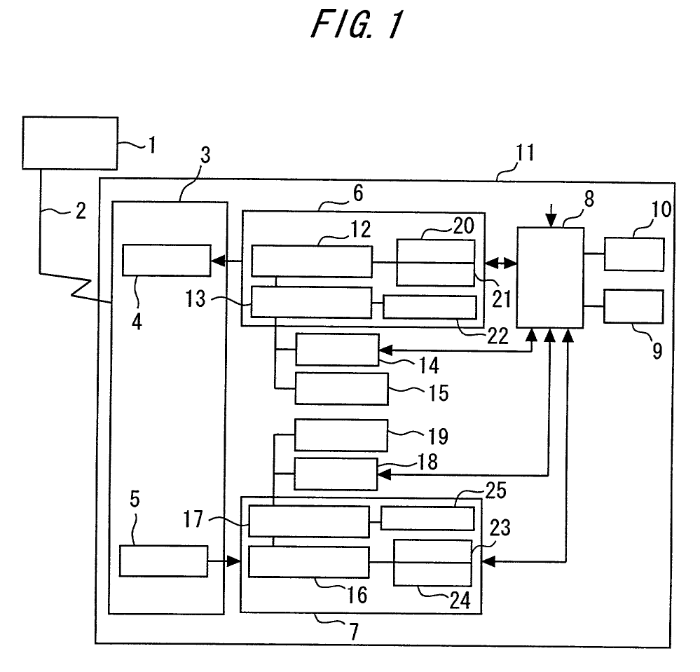

FIG. 1 shows an e-mail communication terminal apparatus according to an embodiment of the present invention. In FIG. 1, reference numeral 1 denotes a known e-mail system that is limited in the amount of data that can be communicated at one time. The e-mail system 1 is connected to a mobile telephpne 11 as an e-mail communication terminal apparatus via a radio base station (not shown) and a communication channel 2. The e-mail system 1, which utilizes the Internet, can connect to not only the mobile telephpne 11 but also other mobile telephpnes and personal computers having a communication means.

The mobile telephpne 11 is provided with a communication control section 3 for performing data transmission and reception with the e-mail system 1, a transmission mail division control section 6 and a reception mail recombination control section 7 (the sections 6 and 7 will be described later), and a whole apparatus control section 8 which controls the sections 3, 6, and 7 and performs other kinds of processing such as processing on data that is input through an input section 10 and I/O processing for a transmission memory 14 or a reception memory 18 on data to be displayed on a display section 9. For example, the input section 10 is a telephone manipulation section including a ten-key pad and the display section 9 is a liquid crystal display.

The transmission mail division control section 6 recognizes the number of characters of mail to be transmitted. If the number of characters is larger than a number that is determined by the limit amount of the e-mail system 1, the transmission mail division control section 6 performs control to divide the mail. The transmission mail division control section 6 is provided with a transmission memory control section 12, a header generation section 13, a total number register 20 and a division number counter 21 that are connected to the transmission memory control section 12, and an identifier register 22 that is connected to the header generation section 13. The total number register 20 holds data indicating a total division number of mail, and the division number counter 21 performs counting to recognize division order of mail. The identifier register 22 temporarily holds an identifier indicating that the mail is divisional mail.

The transmission memory control section 12 accesses the transmission memory 14 and thereby counts the number of characters of transmission mail and calculates a division number. The header generation section 13 accesses a transmission buffer 15 and thereby writes to it a header that has been generated based on the contents of the total number register 20, the division number counter 21, and the identifier register 22.

It is assumed that the transmission memory 14 has such a capacity as to be able to store transmission data of an amount larger than the limit data amount of the e-mail system 1.

The communication control section 3 is composed of a transmission control section 4 and a reception control section 5. The transmission control section 4 has a function of transmitting data that is temporarily stored in the transmission buffer 15 to the e-mail system 1 according to an e-mail transmission control procedure. The reception control section 5 has a function of receiving e-mail that is transmitted from the e-mail system 1 according to an e-mail reception control procedure and temporarily storing a mail body excluding a head portion in a reception buffer 19. Th term “header” as used here means a header that includes such information as a transmission destination and source that is added according to the ordinary e-mail transmission procedure, and is different from a header that includes division information indicating that the mail is divisional mail according to the invention.

The reception mail recombination control section 7 recognizes whether pieces of mail received by the reception control section 5 are divisional mail or not. If they are divisional mail, the reception mail recombination control section 7 performs control to combine the pieces of divisional mail and thereby restore a mail body. The reception mail recombination control section 7 is provided with a reception memory control section 16, a header recognition section 17, a total number register 23 and a recombination number register 24 that are connected to the reception memory control section 16, and an identifier register 25 that is connected to the header recognition section 17. The total number register 23 holds data indicating the total division number of mail. The recombination number register 24 holds data indicating recombination order of mail. The identifier register 25 temporarily holds an identifier indicating that the mail is divisional mail. The reception memory control section 16 accesses the reception memory 18 and thereby secures an area where to write reception mail and recombines pieces of divisional reception mail. The header recognition section 17 accesses the reception buffer 19 and thereby writes a header including division information that is read from divisional reception mail to the total number register 23, the recombination number register 24, and the identifier register 25.

It is assumed that the reception memory 18 has such a capacity as to be able to store reception data of an amount larger than the limit data amount of the e-mail system 1.

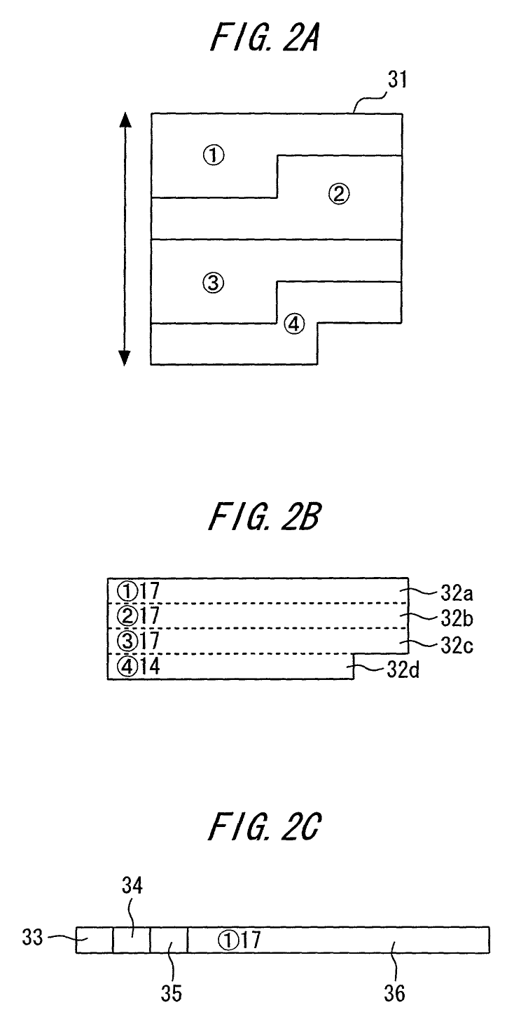

FIG. 2A shows transmission data 31 that is a mail body that a user intends to transmit from the mobile telephpne 11. FIG. 2B shows the contents of the transmission memory 14, that is, data that are obtained by dividing the transmission data 31 and each of which has characters the number of which is less than or equal to a limit character number that is determined by the limit amount of the e-mail system 1. FIG. 2C shows the contents of the transmission buffer 15 which stores one of the divisional transmission data to which a header including division information is added. In FIG. 2A, the transmission data 31 is shown in such a form as to be displayed on the display section 9, for example. To facilitate understanding, it is assumed here that the number of characters of the mail body is 65 and the limit character number that is determined by the limit amount of the e-mail system 1 is 20 (20 bytes).

As shown in FIG. 2B, the transmission data 31 is stored in the transmission memory 14 in such a manner as to be divided into divisional transmission data 32a-32d each having 17 characters, that is, 20 characters of the limit character number minus three characters (bytes) that is used for a header indicating division information. The number of characters of the last divisional transmission data 32d may be smaller than the limit character number 17 depending on the number of characters of the mail body. In this embodiment, the last divisional transmission data 32d has 14 characters.

FIG. 2C shows that the transmission buffer 15 consists of a 1-byte mail identifier section 33, a 1-byte total division number section 34, a 1-byte division number section 35, and a divisional mail sentence section 36 of 17 bytes or less. One of divisional transmission data 32 that are read in order from the head of the transmission memory 14 by the transmission memory control section 12 is written to the divisional mail sentence section 36. The contents of the identifier register 22, the contents of the total number register 20, and the contents of the division number counter 21 are written to the mail identifier section 33, the total division number section 34, and the division number section 35, respectively, by the header generation section 13.

An identifier, for example, an ASCII code corresponding to “#,” indicating that the mail concerned is divisional mail and that the pieces of mail (four pieces of mail in this embodiment) are serial pieces of mail and different from other pieces of divisional mail. In this embodiment, when the divisional transmission data 32a, for example, is written to the divisional mail sentence section 36, “04” (hexadecimal) indicating that the total division number is 4 and “01” (hexadecimal) indicating that the divisional transmission data 32a is the first divisional transmission data are written to the total division number section 34 and the division number section 35, respectively.

When mail has so small a number of characters that it need not be made divisional mail, the head 3-byte portion of the mail body is written to the identifier section 34, the total division number section 35, and the division number section 36. That is, when the number of characters of the mail body is 20 or less, part of the mail body is also written to the identifier section 34, the total division number section 35, and the division number section 36 with a judgment that it is not necessary to divide the mail body.

By incorporating, in the above manner, a character indicating that the mail is divisional mail in a header portion including division information, a reception-side mobile telephpne can easily judge that reception mail is divisional mail.

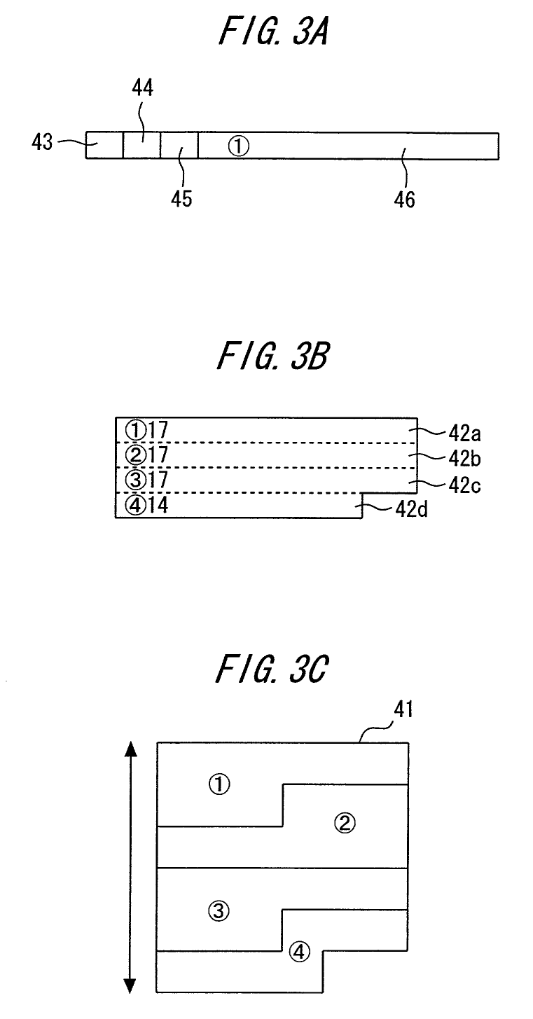

FIGS. 3A-3C show the contents of the reception buffer 19, the contents of the reception memory 18, and reception data 41. As shown in FIG. 3A, divisional reception data received by the mobile telephpne 11 are stored in the reception buffer 19 in such a manner that a header portion including division information is added to it. That is, the reception buffer 19 consists of a 1-byte mail identifier section 43, a 1-byte total division number section 44, a 1-byte division number section 45, and a divisional mail sentence section 46 of 17 bytes or less. Each piece of received mail is stored in the reception buffer 19 in such a manner that a header including such information as a transmission destination and source that was added according to the ordinary e-mail transmission procedure is eliminated from it. The contents of the mail identifier section 43, the contents of the total division number section 44, the contents of the division number section 44 are held by the identifier register 25, the total number register 23, and the recombination number register 24, respectively.

As shown in FIG. 3B, divisional reception data extracted from the divisional mail while eliminating the header portion are stored in the reception memory 18 in areas that are determined based on the division information. That is, the contents of the divisional mail sentence section 46 are stored, as divisional reception data 42a-42d, in the reception memory 18 in areas determined based on the contents held by the recombination number register 24.

FIG. 3C shows reception data 41 as a mail body that has been generated by recombining the plurality of divisional reception data stored in the reception memory 18 and that is displayed on the display section 9, for example.

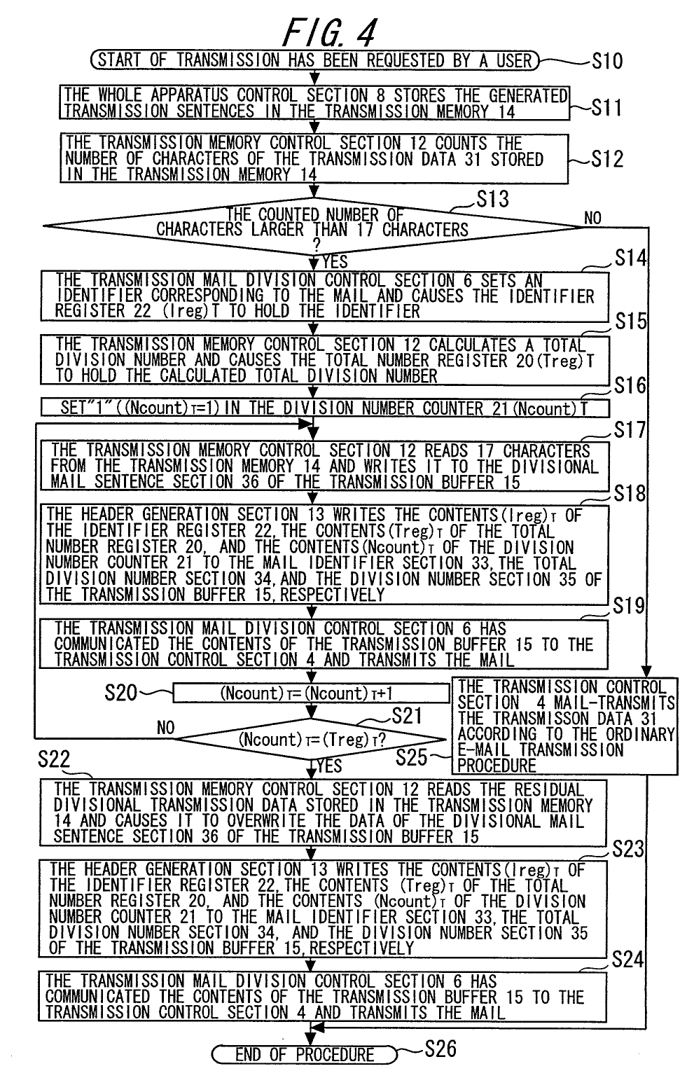

Next, an operation of transmitting mail will be described with reference to a flowchart of FIG. 4. When transmission sentences for mail transmission have been generated and start of their transmission has been requested by a user, at step S11 the whole apparatus control section 8 stores the generated transmission sentences that are displayed on the display section 9, for example, in the transmission memory 14 as transmission data 31.

At step S12, the transmission memory control section 12 counts the number of characters of the transmission data 31 that is stored in the transmission memory 14 by recognizing it based on used areas of the transmission memory 14. At step S13, it is judged whether the counted number of characters is larger than the limit character number or not (in this embodiment, 17 characters, that is, 20 characters of the limit character number that is determined by the limit amount of the e-mail system 1 minus three characters that are used for a header indicating division information). If the number of characters of the transmission data 31 is not larger than the limit character number 17, the process goes to step S25, where the transmission control section 4 mail-transmits the transmission data 31 according to the ordinary e-mail transmission procedure.

If the number of characters of the transmission data 31 is larger than the limit character number 17, at step S14 the transmission mail division control section 6 sets an identifier indicating that the mail is divisional mail and causes the identifier register 22 to hold the identifier. At step S15, the transmission memory control section 12 calculates a total division number based on the limit character number 17 and the total character number of the transmission data 31 that was counted at step S12 and causes the total number register 20 to hold the calculated total division number. At step S16, the transmission memory control section 12 sets “1” ((Ncount)_{T}=1) in the division number counter 21.

At step S17, the transmission memory control section 12 reads the head divisional transmission data of 17 characters from the transmission memory 14 and writes it to the divisional mail sentence section 36 of the transmission buffer 15. At step S18, the header generation section 13 writes the contents (Ireg)_{T} of the identifier register 22, the contents (Treg)_{T} of the total number register 20, and the contents (Ncount)_{T} of the division number counter 21 to the mail identifier section 33, the total division number section 34, and the division number section 35 of the transmission buffer 15, respectively, and thereby adds a header indicating division information to the divisional transmission data.

After the transmission mail division control section 6 has communicated the contents of the transmission buffer 15 to the transmission control section 4, at step S19 the transmission control section 4 adds a header including a transmission destination and source and other information to the contents of the transmission buffer 15 and performs mail transmission according to the ordinary e-mail transmission procedure. When the mail has been transmitted at step S19, at step S20 the transmission mail division control section 6 adds “1” to the numerical value that is held by the division number counter 21. At step S21, the transmission mail division control section 6 compares a numerical value (Ncount)_{T} that has been newly held by the division number counter 21 with the numerical value (Treg)_{T} that is held by the total number register 20. If the two numerical values are different from each other, the process returns to step S17, where the transmission memory control section 12 reads the next divisional transmission data of 17 characters stored in the transmission memory 14 and causes it to overwrite the data of the divisional mail sentence section 36 of the transmission buffer 15. Then, steps S18-S20 are executed again, whereby divisional mail is transmitted.

If it is judged at step S21 that the two numerical values are identical, at step S22 the transmission memory control section 12 reads the residual divisional transmission data (17 characters or less) stored in the transmission memory 14 and causes it to overwrite the data of the divisional mail sentence section 36 of the transmission buffer 15. At step S23, the header generation section 13 writes the contents (Ireg)_{T} of the identifier register 22, the contents (Treg)_{T} of the total number register 20, and the contents (Ncount)_{T} of the division number counter 21 to the mail identifier section 33, the total division number section 34, and the division number section 35 of the transmission buffer 15, respectively, and adds a header indicating division information to the divisional transmission data.

After the transmission mail division control section 6 has communicated the contents of the transmission buffer 15 to the transmission control section 4, at step S24 the transmission control section 4 adds a header including the transmission destination and source and other information to the contents of the transmission buffer 15 and transmits divisional mail to the e-mail system 1 via the communication channel 2 according to the ordinary e-mail transmission procedure. Then, the process for transmitting the divisional mail is finished.

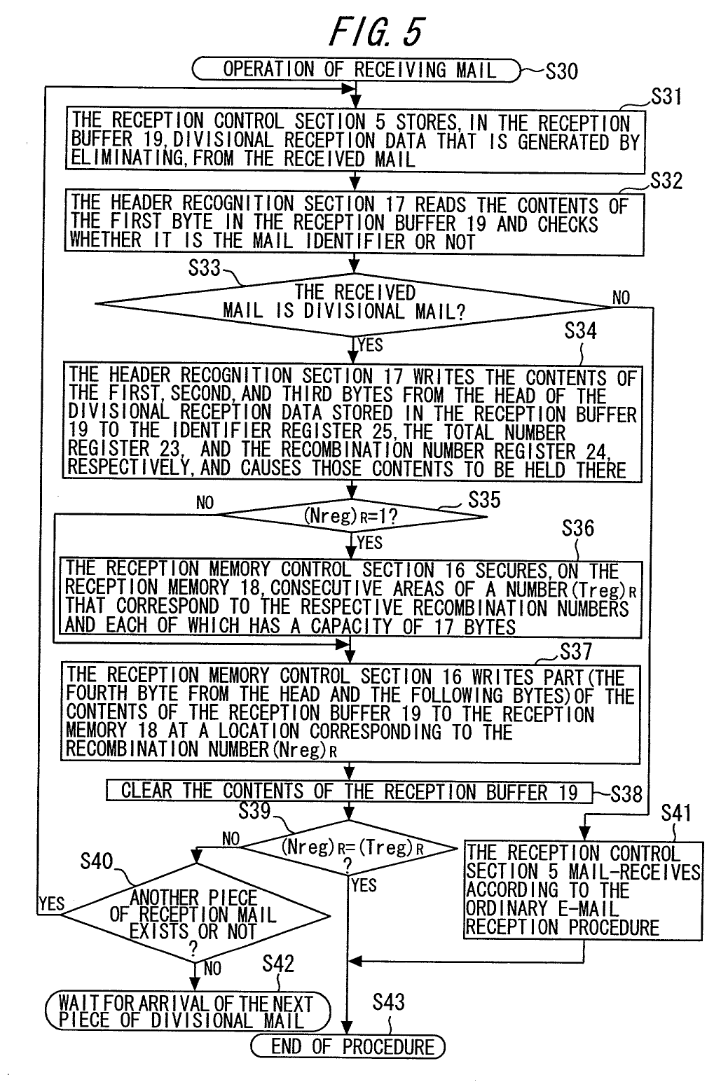

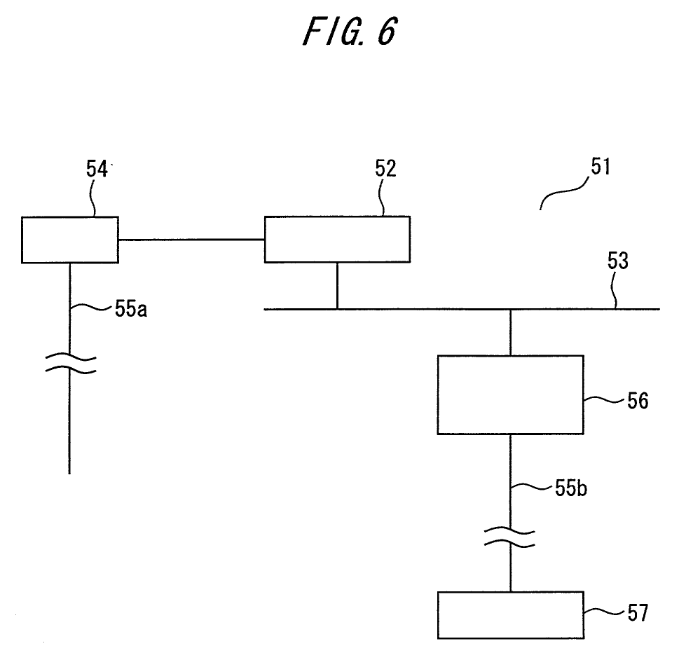

Next, an operation of receiving mail will be described with reference to a flowchart of FIG. 5. When mail has been transmitted from the e-mail system 1 via the communication channel 2, at step S31 the reception control section 5 stores, in the reception buffer 19, divisional reception data that is generated by eliminating, from the received mail, a header including such information as a transmission destination and source that was added according to the ordinary e-mail transmission procedure.

At step S32, the header recognition section 17 writes the contents of the first, second, and third bytes from the head of the divisional reception data stored in the reception buffer 19 to the identifier register 25, the total number register 23, and the recombination number register 24, respectively, and causes those contents to be held there. At step S35, the contents (Nreg)_{R} that has been held by the recombination number register 24 is compared with “1.” If they are identical, at step S36 the reception memory control section 16 secures, on the reception memory 18, consecutive areas of a number (Treg)_{R} (i.e., the numerical value held by the total number register 23) that correspond to the respective recombination numbers and each of which has a capacity of 17 bytes . If they are different from each other, the process goes to step S37 skipping step S36.

The reception memory control section 16 writes part (the fourth byte from the head and the following bytes) of the contents of the reception buffer 19 to the reception memory 18 at a location corresponding to the recombination number (Nreg)_{R} at step S37 and clears the contents of the reception buffer 19 at step S38. At step S39, the division number (Nreg)_{R} is compared with the total division number (Treg)_{R}. If they are identical, the reception process for the divisional reception mail is finished and the whole apparatus control section 8 displays the reception data in the reception memory 18 on the display section 9 and performs other operations. If they are different from each other, the whole apparatus control section 8 judges at step S40 whether another piece of reception mail exists or not. If another piece of reception mail exists, the process returns to step S31 to start the reception process for divisional reception mail again. If not all pieces of the divisional mail have been received yet and there is no other piece of reception mail, the whole apparatus control section 8 waits for arrival of the next piece of divisional mail.

As described above, when e-mail is transmitted, it is automatically judged whether the number of characters of the mail is larger than the number of characters that is limited by the e-mail system or not. If the former is larger than the latter, the mail is transmitted after being divided so that the number of characters of each piece of divisional mail falls within the limit character number. Therefore, a user can transmit e-mail without the need for paying attention to the limit character number; the mobile telephone 11 is superior in ease of use in this respect.

When e-mail is received, whether the reception mail is divisional mail is automatically judged. If the reception mail is divisional mail, pieces of divisional mail are recombined into original mail. Therefore, a user can receive mail the number of characters of which is larger than the limit character number; the mobile telephpne 11 is superior in ease of use in this respect.

Division numbers are incorporated in respective header portions that include division information and pieces of divisional mail are recombined based on the division numbers. Therefore, even if pieces of divisional mail are received in order that is different from the division order, they can be recombined correctly.

The embodiment is directed to the example where transmission data to be transmitted in a divisional manner is characters, the transmission data is not limited to characters and may be image data, sound data, or the like. In the latter cases, the limit byte number is employed in the e-mail system 1 instead of the limit character number. However, the same advantages can be obtained by using the same division procedure and recombination procedure as in the embodiment.

In the mobile telephpne 11, the number of characters or bytes based on which whether to divide transmission data is judged may be set in advance when a related notice is transmitted from the e-mail system 1.

Although in the embodiment the e-mail communication terminal apparatus is a mobile telephpne that is connected to the e-mail system by radio, the same advantages can be obtained by a personal computer or the like having a communication means for establishing connection to the e-mail system by wire.

As described above, according to the invention, in transmitting or receiving data having an amount that is larger than a limit amount of data that an e-mail system to which to establish connection can communicate at one time, the data is transmitted in a divisional manner or received data are recombined. This makes it possible to transmit and receive data having an amount that is larger than the limit amount of the e-mail system.

In the invention, division information is added to data when the data is transmitted in a divisional manner and received data are recombined based on added division information. This makes it possible to correctly restore divisional reception data having an amount that is larger than the limit amount of the e-mail system.

Further, in the invention, in transmitting data having an amount that is larger than a limit amount of data that an e-mail system to which to establish connection can communicate at one time, the data is transmitted in a divisional manner by radio. This makes it possible to transmit data having an amount that is larger than the limit amount of the e-mail system while providing superior portability.

Here, the e-mail communication terminal apparatus may further comprise information adding means for adding division information to the divisional data produced by the division control means, wherein the recombination control means recombines, based on division information, received divisional data to which the division information is added.

In the e-mail communication terminal apparatus, the division information may include information indicating that the transmission data is divisional mail.

In the e-mail communication terminal apparatus, the division information may include information indicating recombination order.

The present invention has been described in detail with respect to various embodiments, and it will now be apparent from the foregoing to those skilled in the art that changes and modifications may be made without departing from the invention in its broader aspects, and it is the invention, therefore, in the appended claims to cover all such changes and modifications as fall within the true spirit of the invention.

The entire disclosure of Japanese Patent Application No. 2000-207504 filed on Jul. 7, 2000 including specification, claims, drawings and summary are incorporated herein by reference in its entirety.

What is claimed is:

1. An e-mail communication terminal apparatus to be connected to an e-mail system that is limited in an amount of data that can be communicated at one time, comprising:
division control means for dividing transmission data into divisional data based on a predetermined data amount when the transmission data has an amount larger than the communicable data amount of the e-mail system;
transmitting means for transmitting the divisional data produced by said division control means;
receiving means for receiving data; and
recombination control means for recombining the data received by said receiving means when the data are divisional data that were separated from each other by a transmission source.

2. The e-mail communication terminal apparatus according to claim 1, further comprising information adding means for adding division information to the divisional data produced by said division control means, wherein the recombination control means recombines, based on division information, received divisional data to which the division information is added.

3. The e-mail communication terminal apparatus according to claim 2, wherein the division information includes information indicating that the transmission data is divisional mail.

4. The e-mail communication terminal apparatus according to claim 2, wherein the division information includes information indicating recombination order.

5. An e-mail communication terminal apparatus to be connected, by radio, to an e-mail system that is limited in an amount of data that can be communicated at one time, comprising:
division control means for dividing transmission data into divisional data based on a predetermined data amount when the transmission data has an amount larger than the communicable data amount of the e-mail system; and
radio transmitting means for transmitting the divisional data produced by said division control means.
